(19) United States
(12) Patent Application Publication
(10) Pub. No.: US 2025/0209469 A1
(43) Pub. Date: Jun. 26, 2025

(54) REMOTE CUSTOMER SUPPORT OPERATION PROXY SYSTEM, REMOTE CUSTOMER SUPPORT PROXY TERMINAL, AND METHOD

(71) Applicant: Toshiba Tec Kabushiki Kaisha, Tokyo (JP)

(72) Inventor: Katsunori SATO, Mishima Shizuoka (JP)

(21) Appl. No.: 18/771,818

(22) Filed: Jul. 12, 2024

(30) Foreign Application Priority Data
Dec. 25, 2023 (JP) 2023-218260

(51) Int. Cl. G06Q 30/015

(52) U.S. Cl. CPC G06Q 30/015

(57) ABSTRACT

According to an embodiment, a remote customer service proxy system is provided to permit remote personnel to perform reception processing operations for many different locations and businesses. The system includes a communication server connectable to a reception systems at different remote locations, a proxy server, a proxy-side support terminal connected to the local network, and a proxy terminal, each connected to a local network. The proxy-side support terminal receives, via the communication server, a request for customer service from a customer reception system and identifies a self-service terminal corresponding to the customer reception system sending the request. The proxy terminal receives the identity of the self-service terminal, executes a reception system program corresponding to the identified self-service terminal, and outputs, via the communication server, a reception system completion notification to an output device corresponding to the identified self-service terminal.

### CROSS-REFERENCE TO RELATED APPLICATION

This application is based upon and claims the benefit of priority from Japanese Patent Application No. 2023-218260, filed Dec. 25, 2023, the entire contents of which are incorporated herein by reference.

### FIELD

Embodiments of the present disclosure relate to a remote customer support operation proxy system, a remote customer support proxy terminal for a remote customer support operation proxy system, and a method of a remote customer support operation system.

### BACKGROUND

In recent years, there are an increasing number of companies that have been looking for a reduction in labor costs so have adopted self-service kiosks, terminals, and the like for handling entrance/reception jobs at the entrance of facilities. Specifically, self-service terminals are installed in reception halls or entranceways of a facility and then intended users of the facility operates the terminals by themselves to perform the necessary reception/entrance processing. However, with such systems, not all of the users will be able to operate the terminals by themselves. Therefore, it is necessary in such cases to have employees who can support the self-service terminal on standby such as at the reception hall or entrance area, which reduces the manpower savings that would otherwise be possible with such systems.

### BRIEF DESCRIPTION OF THE DRAWINGS

FIG. 1 is a block diagram of a system including an operation proxy system.

FIG. 2 is a schematic illustrating a configuration of a reference table.

FIG. 3 is a block diagram of a support terminal.

FIG. 4 is a block diagram of a proxy terminal.

FIG. 5 is a block diagram depicting certain functional aspects of an operation proxy system.

FIG. 6 is a sequence chart for operation explanation of a first embodiment.

FIG. 7 is a screen transition diagram used for an operation explanation of a first embodiment.

FIG. 8 is a flowchart of information processing executed by a processor of a proxy terminal according to a proxy control program.

FIG. 9 is a sequence chart used for operation explanation of a second embodiment.

### DETAILED DESCRIPTION

Embodiments of the present disclosure provide an operation proxy system and a proxy terminal that can achieve manpower savings by permitting support operations from a remote place to help a user of a self-service terminal.

In an embodiment, a remote customer service operation proxy system includes a communication server connectable to a plurality of customer reception systems at a plurality of remote locations, a proxy server connected to the communication server by a local network, a proxy-side support terminal connected to the local network, and a proxy terminal connected to the local network. The proxy-side support terminal is configured to receive, via the communication server, a request for customer service from a customer reception system among the plurality of customer reception systems and identify a self-service terminal corresponding to the customer reception system sending the request. The proxy terminal is configured to receive the identity of the self-service terminal, execute a reception system program corresponding to the identified self-service terminal, and output, via the communication server, a reception system completion notification to an output device corresponding to the identified self-service terminal.

Embodiments of an operation proxy system and terminal that can achieve manpower saving by permitting performance of support operations from a remote place on behalf of a user who cannot operate a self-service terminal are explained below with reference to the drawings.

Certain example embodiments describe an operation proxy system 10 that can be used to remotely perform or support a self-service terminal operation for terminals located at the facilities of various business categories such as a karaoke bar, a rental space, or a fitness club. The self-service terminal can also be or include a POS (Point Of Sales) terminal.

### First Embodiment

### Explanation of a System Overall Configuration

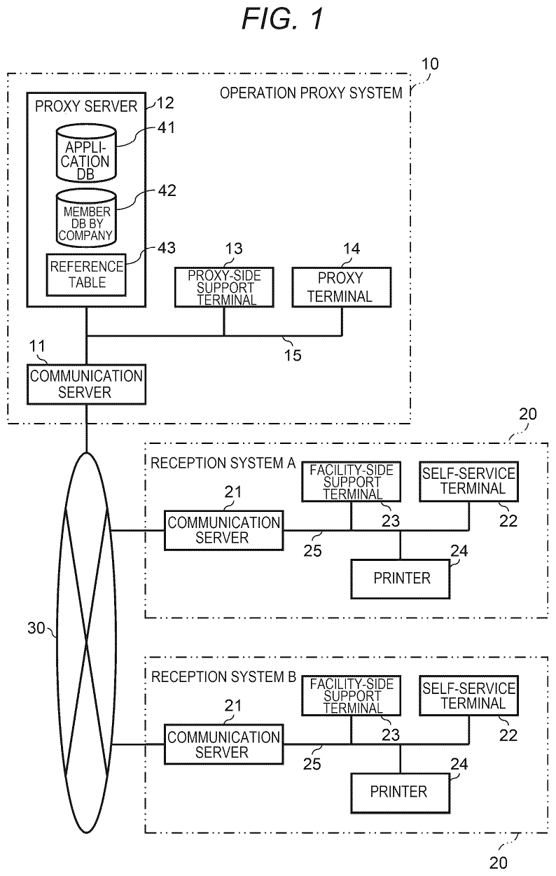

FIG. 1 is a block diagram illustrating an overall configuration of a system including an operation proxy system 10 for remote customer support or the like. This remote customer support system includes operation proxy system 10 and a plurality of reception systems 20. The reception systems 20 may be constructed for each of the various facilities of the various business categories described above. For example, a reception system A is at a reception (entrance) of a karaoke bar. A reception system B is at a reception (entrance) of a fitness club. In principle, the reception area is an unmanned reception area—that is, an employee is not stationed at the reception area for customer check-in processing and the like. The operation proxy system 10 can be at a support center independent and separate from the facilities at which the reception systems 20 are disposed. The support center can be a remote location where persons in charge of customer service who are to support reception jobs (processing) and the like for the facilities are permanently stationed.

Each reception system 20 includes a communication server 21, a self-service terminal 22, a facility-side support terminal 23, and a printer 24. In the reception system 20, the communication server 21, the self-service terminal 22, the facility-side support terminal 23, and the printer 24 are connected by a network 25, such as a LAN (Local Area Network), to enable data communication among these components. The network 25 may be wired or may be wireless.

The communication server 21 connects a wide area network 30 such as the Internet. The communication server 21 relays data communication performed between the reception system 20 and the operation proxy system 10 via the wide area network 30.

The self-service terminal 22 is a terminal that processes, with self-service operation by a user who uses a facility such as a karaoke bar, a rental space, or a fitness club, a reception job necessary for the user to enter the facility. For example, if the user enters the facility, the karaoke bar receives input of a member ID, the number of users, and selection of a karaoke course (a usage time, all-you-can-drink, and the like). Therefore, the self-service terminal 22 of the karaoke bar sequentially displays screens for receiving, according to the self-service operation by the user, the input of the member ID, the input of the number of users, the selection of the karaoke course (the usage time, the all-you-can-drink, and the like). The self-service terminal 22 captures information input via the screens and prints a receipt form with a printer upon finishing capturing all information necessary in the reception job. The reception slip is a print-out of the information input in the reception job and is used for adjustment of a usage fee if the user finishes using the facility.

The same applies to the self-service terminals 22 in the business categories other than the karaoke bar. That is, the self-service terminal 22 is an information processing terminal having a function of transitioning a screen with self-service operation of a user, capturing information necessary in a reception job at the time when the user enters a facility, and printing a reception slip according to necessary. Note that the self-service terminal 22 may also have a function of processing an adjustment job for a usage fee.

The facility-side support terminal 23 is a communication terminal for a user who cannot operate the self-service terminal 22 to receive remote support. The facility-side support terminal 23 enables data communication including a phone call with a proxy-side support terminal 13 incorporated in the operation proxy system 10. The user who cannot operate the self-service terminal 22 can receive support for a reception job or an adjustment job by making a phone call to customer service at the support center through the facility-side support terminal 23. In particular, concerning the reception job, the user is capable of receiving operation proxy support from a person operating a proxy terminal 14 located in the support center who can also perform input to the self-service terminal 22 on behalf of the user. Note that “the user cannot operate the self-service terminal 22” includes, in this context, not only a case in which the user cannot operate the self-service terminal 22 because of a physical disability or the like but also a case in which the operation is simply too difficult for the user or the user causes delays in operation because the user does not understand the information that should be input to the self-service terminal 22.

The printer 24 is an output device for printing a reception slip or the like dispensed to the user who received the operation proxy support. The printer 24 is a standalone printer independent of a printer mounted on the self-service terminal 22. A receipt printer, a label printer, a multifunction peripheral, and the like can be the printer 24.

Incidentally, an operation for disposing the self-service terminal 22, the facility-side support terminal 23, and the printer 24 on a counter table equipped at a reception of the facility is conceivable. In that case, since the printer 24 prints the reception slip or the like dispensed to the user who received the support via the facility-side support terminal 23, the printer 24 is preferably disposed near the facility-side support terminal 23. Note that, in FIG. 1, one self-service terminal 22, one facility-side support terminal 23, and one printer 24 are illustrated. However, two or more self-service terminals 22, two or more facility-side support terminals 23, and two or more printers 24 may be provided. For example, a configuration may be adopted in which a plurality of self-service terminals 22 and one facility-side support terminal 23 and one printer 24 are provided or a configuration may be adopted in which a plurality of self-service terminals 22 and a plurality of facility-side support terminals 23 and one printer 24 are provided. In the latter case, the plurality of facility-side support terminals 23 share the printer 24.

The operation proxy system 10 includes a communication server 11, a proxy server 12, a proxy-side support terminal 13, and a proxy terminal 14. The operation proxy system 10 connects the communication server 11, the proxy server 12, the proxy-side support terminal 13, and the proxy terminal 14 through a network 15, such as a LAN, and enables data communication among them. The network 15 may be wired or may be wireless.

The communication server 11 connects a wide area network 30 such as the Internet. The communication server 11 relays data communication performed between the operation proxy system 10 and the reception systems 20 via the wide area network 30.

The proxy server 12 is a computer and plays a central role in the operation proxy system 10. The proxy server 12 provides necessary services and information to the proxy-side support terminal 13 and the proxy terminal 14. The proxy server 12 may be on-premise with the proxy-side support terminal 13 and proxy terminal 14 or may be provided by a cloud computing environment.

The proxy-side support terminal 13 is a communication terminal for the person in charge of customer service (e.g., a customer service manager) and can be used to provide support to the user who cannot operate the self-service terminal 22. The proxy-side support terminal 13 enables data communication including phone calls to the facility-side support terminals 23 incorporated in the respective reception systems 20.

The proxy terminal 14 is an information processing terminal that can function in the same manner as the self-service terminals 22 incorporated in the various reception systems 20. The proxy terminal 14 incorporates devices necessary for functioning as the self-service terminals 22, for example, a keyboard, a touch panel, and a display. For example, a general-purpose personal computer and a tablet terminal can be the proxy terminal 14 in some examples.

In the operation proxy system 10, the proxy server 12 includes an application database 41, a member database by company 42, and a reference table 43 in order to provide necessary services to the proxy-side support terminal 13 and the proxy terminal 14.

The application database 41 is an aggregation of application software necessary for causing the proxy terminal 14 to equivalently function as any one of the self-service terminal 22 among the various reception systems being supported. In this embodiment, a single proxy terminal 14 can be caused to function as the self-service terminals 22 incorporated in any one of the reception systems 20 of the different business categories. Generally, when business categories are different, application software implemented by the self-service terminals 22 of the businesses are also different. The application database 41 stores application software corresponding to each of the self-service terminals 22 of at least each different business category. In the following explanation, the application software executed in the self-service terminals 22 is referred to as a self-service terminal application. Application software managed in the application database 41 is referred to as a proxy application.

The member database by company 42 is an aggregation of member databases for each of the companies that operate facilities among the various different business categories. A member database stores member data for members registered with a company. The member data includes items such as a member ID, a name, sex, age, date of member registration, and membership expiration date. The member ID is unique identification information allocated to each of the registered members. A user who uses a facility can become a member by performing a member registration with the company that operates the facility or the like. A member may receive additional services or benefits such as a discount by inputting the member ID via the self-service terminal 22 when entering the facility.

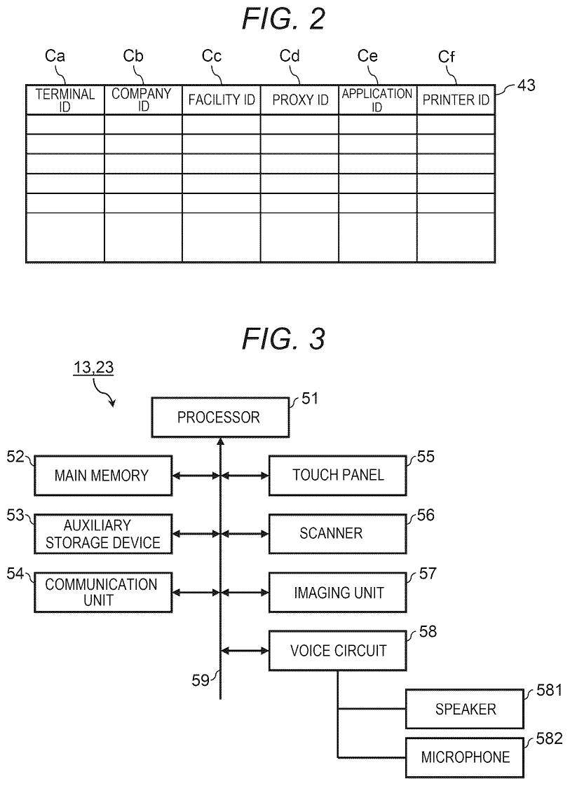

The reference table 43 (see FIG. 2) includes a column Ca for a terminal ID, a column Cb for a company ID, a column Cc for a facility ID, a column Cd for a proxy ID, a column Ce for an application ID, and a column Cf for a printer ID. The terminal ID is identification information for a facility-side support terminal 23. Specific terminal IDs are generally set for each of the facility-side support terminals 23. In the following explanation, this terminal ID is also referred to as a support terminal ID. In the column Ca, support terminal IDs of facility-side support terminals 23 respectively incorporated in the reception systems 20 are listed.

Note that specific terminal IDs can also be set for each of the self-service terminals 22 in the facilities as well. In the following explanation, this terminal ID is referred to as a self-service terminal ID. The support terminal ID and the self-service terminal ID do not match each other. The support terminal ID and the self-service terminal ID uniquely distinguish terminals operating in a specific store of a specific company. The support terminal ID and the self-service terminal ID may include combinations with a company ID and/or a facility ID, or may not include the company ID and the facility ID. In this embodiment, the support terminal ID and the self-service terminal ID do not include the company ID and the facility ID therein.

The company ID is identification information of a company that operates the facility. Specific company ID are set for each of the companies. The same company may operate multiple facilities.

The facility ID is identification information of the facility in which the reception system 20 is constructed. Specific facility IDs are set for each of the facilities.

The proxy ID is set for the proxy terminal 14 assigned to (or set for) the terminal IDs or the like. The proxy ID can be used as a terminal ID set when the proxy terminal 14 operates as a self-service terminal 22 of a particular facility. In other words, the proxy ID is a terminal ID used when the proxy terminal 14 operates as a self-service terminal 22 (though not actually installed in the store specified by the company ID and the facility ID). That is, when proxy terminals operates as a remote self-service terminal. The proxy ID can be uniquely distinguishable identification information set for the proxy terminal 14 to operate as a remote self-service terminal in the operation proxy system. The proxy ID may include a combination of the company ID, the facility ID, and the terminal ID to indicate the proxy terminal is a remote terminal or may be information that does not include the company ID and the facility ID.

The application ID is identification information of the proxy application stored in the application database that is to be used when acting as remote support terminal. Specific application IDs are generally set for each of the proxy applications. In the column Ce, an application ID of a proxy application matching the self-service terminal application executed by the facility-side support terminal 23 having the support terminal ID in the column Ca is provided.

The printer ID is identification information of a printer 24 associated with the terminal ID. Specific printer IDs are generally set for each of the printers 24 incorporated in the reception systems 20.

### Configuration Explanation of the Support Terminal

FIG. 3 is a block diagram illustrating a configuration of the proxy-side support terminal 13 and the facility-side support terminal 23. The proxy-side support terminal 13 and the facility-side support terminal 23 can have the same general configuration. Accordingly, in FIG. 3 and in the following, the proxy-side support terminal 13 and the facility-side support terminal 23 are explained together.

The support terminals 13 and 23 each include a processor 51, a main memory 52, an auxiliary storage device 53, a communication unit 54, a touch panel 55, a scanner 56, an imaging unit 57, a voice circuit 58, and a system transmission line 59. The system transmission line 59 includes an address bus, a data bus, and a control signal line. The system transmission line 59 connects the processor 51 and the other units and transmits data signals exchanged between the processor 51 and the other units.

The processor 51, the main memory 52, the auxiliary storage device 53, and the communication unit 54 are connected through the system transmission line 59 and may be considered to be a computer. The touch panel 55, the scanner 56, and the imaging unit 57 and the voice circuit 58 (e.g., a microphone) may be external devices that are connected to a computer to form the support terminals 13 and 23.

The processor 51 controls the units according to an operating system and/or application programs in order to implements various functions of the support terminals 13 and 23. The processor 51 is, for example, a CPU (Central Processing Unit).

The main memory 52 includes a nonvolatile memory region and a volatile memory region. The main memory 52 stores the operating system or the application programs in the nonvolatile memory region. The main memory 52 sometimes stores, in the nonvolatile or volatile memory region, data necessary for the processor 51 in executing processing for controlling the units. The main memory 52 uses the volatile memory region as a work area in which data can be rewritten as appropriate by the processor 51. The nonvolatile memory region is, for example, a ROM (Read Only Memory). The volatile memory region is, for example, a RAM (Random Access Memory).

The auxiliary storage device 53 can be, for example, an EEPROM® (Electric Erasable Programmable Read-Only Memory), an HDD (Hard Disk Drive), an SSD (Solid-State Drive), or the like. The auxiliary storage device 53 stores data to be used by the processor 51 in performing various kinds of processing, data created by the processing in the processor 51, and the like. The auxiliary storage device 53 sometimes stores the application programs.

The communication unit 54 is an communication interface (I/F) for performing data communication with other equipment connected via the network 15 or the network 25. That is, the communication unit 54 of the proxy-side support terminal 13 is capable of performing data communication with the communication server 11, the proxy server 12, and the proxy terminal 14 connected via the network 15. The communication unit 54 of the facility-side support terminal 23 is capable of performing data communication with the communication server 21, the self-service terminal 22, and the printer 24 connected via the network 25.

The touch panel 55 functions as an input device and a display device. The touch panel 55 displays screens necessary according to the control of the processor 51. The touch panel 55 detects touch operations and outputs signals indicating touch positions to the processor 51.

The scanner 56 scans and reads a machine readable code such as a barcode or a two-dimensional code. For example, when a member user starts application software that is exclusively for members, a barcode or a two-dimensional code indicating a member ID is displayed on the member user's smartphone, and the scanner 56 can read the barcode or the two-dimensional code displayed on the smartphone.

The imaging unit 57 includes a camera and captures an images. Specifically, in this case, the imaging unit 57 images a person standing in front of the support terminal (13 or 23). Specifically, the imaging unit 57 of the proxy-side support terminal 13 acquires images of the operator of the proxy-side support terminal 13 (the person in charge of customer service). The imaging unit 57 of the facility-side support terminal 23 acquires images the user receiving remote support for operating the self-service terminal 22. An image from the imaging unit 57 of the proxy-side support terminal 13 is displayed on the touch panel 55 of the facility-side support terminal 23 while the proxy-side support terminal 13 is connected thereto. Similarly, an image from the imaging unit 57 of the facility-side support terminal 23 may be displayed on the touch panel 55 of the proxy-side support terminal 13 while the facility-side support terminal 23 is connected thereto.

In the voice circuit 58, a speaker 581 (functioning as a voice output unit) and a microphone 582 (functioning as a voice input unit) are connected. The voice circuit 58 converts voice data input via the communication unit 54 into voice and outputs the voice from the speaker 581. The voice circuit 58 converts voice taken in via the microphone 582 into voice data and outputs the voice data to the communication unit 54. By operation of the voice circuit 58, the operator of the proxy-side support terminal 13, can make a phone call with the user of the facility-side support terminal 23.

### Configuration Explanation of the Proxy Terminal

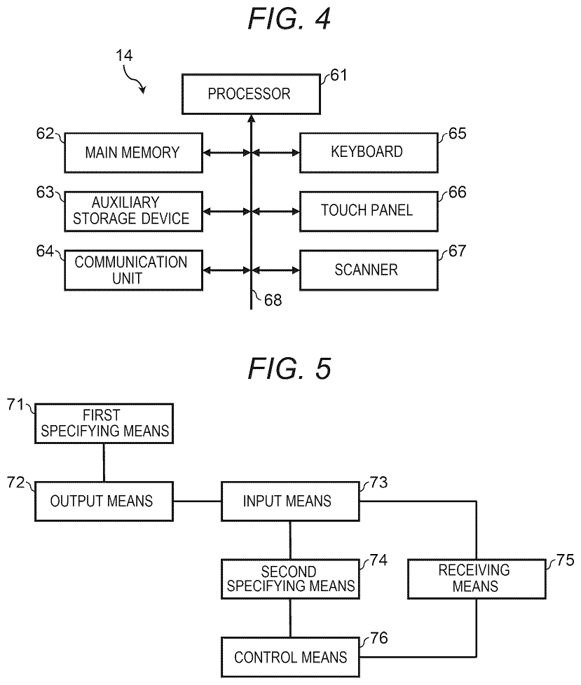

FIG. 4 is a block diagram illustrating a configuration of the proxy terminal 14. The proxy terminal 14 includes a processor 61, a main memory 62, an auxiliary storage device 63, a communication unit 64, a keyboard 65, a touch panel 66, a scanner 67, and a system transmission line 68. The system transmission line 68 includes an address bus, a data bus, and a control signal line. The system transmission line 68 connects the processor 61 and the other units and transmits data signals exchanged between the processor 61 and the other units.

The processor 61, the main memory 62, the auxiliary storage device 63, and the communication unit 64 are connected through the system transmission line 68 and can be considered to form a computer. The keyboard 65, the touch panel 66, and the scanner 67 can be external devices that are connected to configure the proxy terminal 14. Note that the devices included in the proxy terminal 14 are not limited to the keyboard 65, the touch panel 66, and the scanner 67. The proxy terminal 14 may further include devices necessary for the proxy terminal 14 to operate more similarly to the self-service terminal 22.

The processor 61 controls the units according to an operating system and/or application programs in order to implement various functions of the proxy terminal 14. The processor 61 is, for example, a CPU. The processor 61 can be a multicore processor that includes a plurality of processor cores and is capable of executing a plurality of kinds of processing in parallel.

The main memory 62 includes a nonvolatile memory region and a volatile memory region. The main memory 62 stores the operating system or the application programs in the nonvolatile memory region. The main memory 62 sometimes stores, in the nonvolatile or volatile memory region, data necessary for the processor 61 in executing processing for controlling the units. The main memory 62 uses the volatile memory region as a work area in which data can be rewritten as appropriate by the processor 61. The nonvolatile memory region is, for example, a ROM. The volatile memory region is, for example, a RAM.

The auxiliary storage device 63 can be, for example, an EEPROM®, an HDD, an SSD, or the like. The auxiliary storage device 63 stores data to be used by the processor 61 in performing various kinds of processing, data created by the processing in the processor 61, and the like. The auxiliary storage device 63 sometimes stores the application programs.

The communication unit 64 is a communication interface (I/F) for performing data communication with other equipment connected via the network 15 such as the communication server 11, the proxy server 12, and the proxy-side support terminal 13.

Any proxy application stored in the application database 41 can be loaded into the main memory 62 or the auxiliary storage device 63, the proxy terminal 14 can execute the proxy application and thus operate as a terminal having the same functions as the self-service terminal 22 which executes a self-service terminal application matching the proxy application. The proxy terminal 14 may be considered to emulate the functions and operations of a self-service terminal 22 by executing the proxy application.

### Function Explanation of the Operation Proxy System

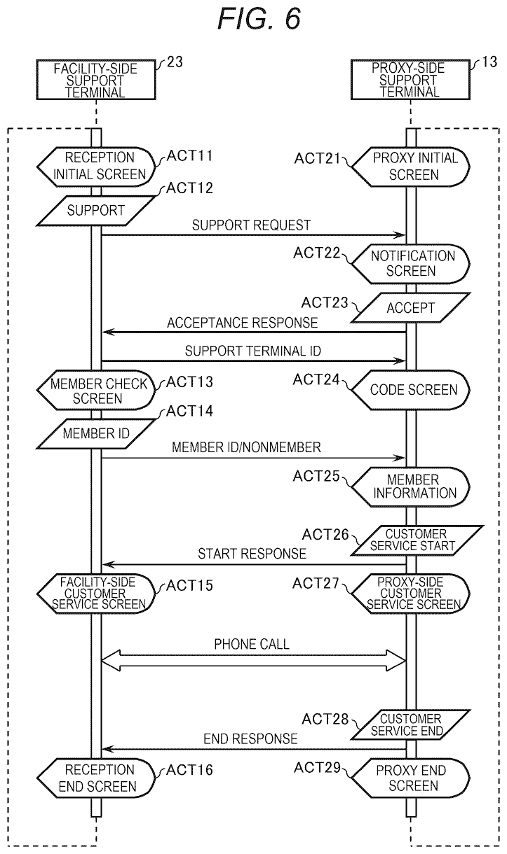

FIG. 5 is a block diagram illustrating functional aspects of the operation proxy system 10. As illustrated, the operation proxy system 10 has functions corresponding to first specifying means 71, output means 72, input means 73, second specifying means 74, receiving means 75, and control means 76. These functions can be provided or implemented independently by the proxy server 12, the proxy-side support terminal 13, or the proxy terminal 14 or by cooperation between these devices.

The first specifying means 71 specifies (identifies) the self-service terminal 22 which is the operation proxy target based on communication information (request) for remote customer services. In this context, the communication information for remote customer services is information transmitted and received between the facility-side support terminal 23 incorporated in the reception system 20 including the operation proxy target self-service terminal 22 and the proxy-side support terminal 13 of the operation proxy system 10. This information includes a support terminal ID of the facility-side support terminal 23. The first specifying means 71 refers to the reference table 43 with the support terminal ID of the facility-side support terminal 23 acquires a company ID and a facility ID correlated with the support terminal ID, and specifies, as the operation proxy target self-service terminal 22, the self-service terminal 22 incorporated in the reception system 20 of a facility identified by the company ID and the facility ID. In this way, the first specifying means 71 is implemented by cooperation of the proxy server 12 and the proxy-side support terminal 13.

The output means 72 outputs an identification code for identifying the self-service terminal 22 specified by the first specifying means 71. The self-service terminal 22 incorporated in the reception system 20 can be a specialized model for performing reception jobs at the particular facility at which the reception system 20 is constructed. Therefore, the output means 72 outputs, as the identification code of the self-service terminal 22, a two-dimensional code encoding the company ID, the facility ID, and a proxy ID of the reception system 20. For example, the output means 72 displays or otherwise outputs the two-dimensional code including the company ID, the facility ID, and the proxy ID on the touch panel 55 of the proxy-side support terminal 13. As explained above, the output means 72 can be implemented by cooperation of the proxy server 12 and the proxy-side support terminal 13. Note that, in some examples, the output means 72 may print the two-dimensional code on paper or the like using a printer in the operation proxy system 10 and output the two-dimensional code as a printed sheet, slip of paper, or the like. Alternatively, the output means 72 may output the company ID, the facility ID, and the proxy ID included in the two-dimensional code by other methods of communication.

The input means 73 permits inputting of the identification code of self-service terminal 22 (proxy operation target) specified by the first specifying means 71 based on the communication information for remote customer services. As explained above, the identification code for self-service terminal 22 can be displayed on the touch panel 55 of the proxy-side support terminal 13 as a two-dimensional code. The input means 73 inputs the identification code of the self-service terminal 22 by scanning and reading the two-dimensional code displayed on the touch panel 55 with the scanner 67 of the proxy terminal 14. The input means 73 may get the identification code of the self-service terminal 22 by scanning and reading a printed two-dimensional code with the scanner 67 of the proxy terminal 14. The proxy terminal 14 may receive, by data communication via the network 15, data of the two-dimensional code corresponding to the company ID, the facility ID, and the proxy ID, sent from the proxy-side support terminal 13. In this way, the input means 73 can be implemented by the proxy terminal 14 alone.

The second specifying means 74 identifies an output device correlated with the self-service terminal 22. In this context, printer 24 included in the reception system 20 is an output device correlated with the self-service terminal 22. For example, the second specifying means 74 checks the reference table 43 against the support terminal ID and acquires a printer ID correlated with the support terminal ID. The second specifying means 74 specifies the printer 24 matching the printer ID as the output device correlated with the self-service terminal 22. In this way, the second specifying means 74 is implemented by cooperation of the self-service terminal 22, the proxy server 12, and the proxy terminal 14.

The receiving means 75 receives, at the proxy terminal 14, operation inputs of the self-service terminal 22 specified as the operation proxy target. The proxy terminal 14 with the proxy application installed and executing functions as the self-service terminal 22 operating with a self-service terminal application matching the proxy application. The receiving means 75 receives operation inputs of the self-service terminal 22 via the keyboard 65, the touch panel 66, or the like of the proxy terminal 14 executing the proxy application. In this way, the receiving means 75 is implemented by the proxy terminal 14 alone.

The control means 76 causes the proxy terminal 14 to operate as if it was the self-service terminal 22 specified as the operation proxy target and controls the proxy terminal 14 to output information to the output device specified by the second specifying means 74. The control means 76 checks the reference table 43 against the support terminal ID of the facility-side support terminal 23 and acquires an application ID correlated with the support terminal ID. The control means 76 loads the proxy application identified by the application ID from the application database 41 and installs this proxy application in the proxy terminal 14. In this way, the proxy terminal 14 operates as substantially similar to the proxy operation target self-service terminal 22. Specifically, the control means 76 causes the proxy terminal 14 to operate as the self-service terminal 22. The control means 76 outputs information to the output device specified by the second specifying means 74. The output information is, for example, printing data. The control means 76 outputs the printing data to the printer 24 specified by the second specifying means 74. In this way, the control means 76 is implemented by cooperation of the proxy server 12 and the proxy terminal 14.

### Operation Explanation of the First Embodiment

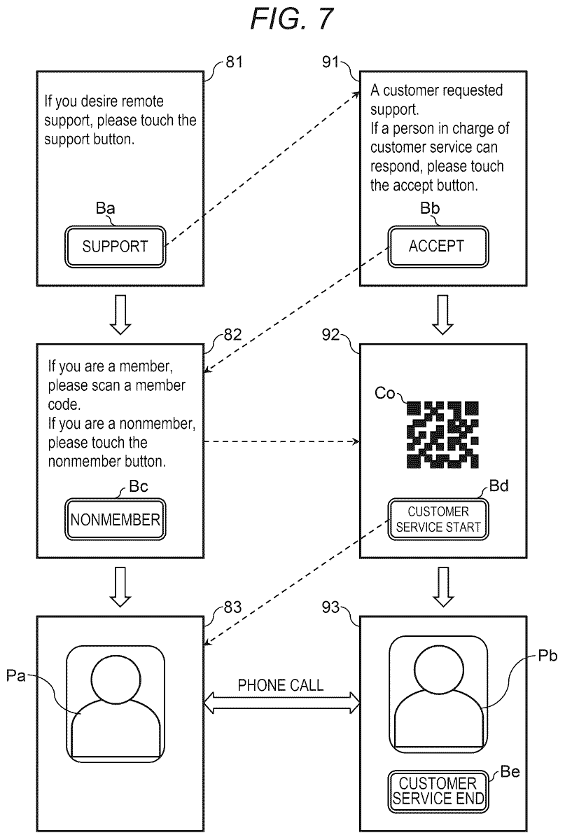

Next, a certain operations in this embodiment are explained. First, mutual operations between the facility-side support terminal 23 included in a reception system 20 and the proxy-side support terminal 13 of the operation proxy system 10 are explained with reference to FIG. 6 and a screen transition diagram in FIG. 7. Note that interactions and operations of the facility-side support terminals 23 included in other reception systems 20 with the proxy-side support terminal 13 are generally the same as the following explanation and particular details for different reception systems may be omitted.

### Operation of the Support Terminal

As illustrated in FIG. 6, in a default state in which operation is not yet received, the facility-side support terminal 23 sets, in ACT 11, the screen of the touch panel 55 as a reception initial screen 81 (see FIG. 7). The reception initial screen 81 is a screen on which a support button Ba is displayed together with operation guidance in case a user cannot operate the self-service terminal 22 and wants to receive remote support. The support button Ba is for requesting the remote support. In ACT 12, the facility-side support terminal 23 waits for the support button Ba to be touched.

In ACT 21, before an operation is received, the proxy-side support terminal 13 sets the screen of the touch panel 55 as a proxy initial screen. The proxy initial screen is optional. A blank screen or the like can be displayed as the proxy initial screen.

A user who cannot operate a self-service terminal 22 moves to the facility-side support terminal 23. The user touches the support button Ba of the reception initial screen 81. When the support button Ba is touched, the facility-side support terminal 23 transmits a signal of a support request event to the proxy-side support terminal 13. The signal of the support request event is output from the facility-side support terminal 23 to the network 25 of the reception system 20 and transmitted to the proxy-side support terminal 13 via the communication server 21, the wide area network 30, the communication server 11, and the network 15 of the operation proxy system 10.

In ACT 22, the proxy-side support terminal 13, which received the signal of the support request event, sets the screen of the touch panel 55 as a notification screen 91 (see FIG. 7). The notification screen 91 is a screen on which an acceptance button Bb is displayed together with guidance for notifying customer services that support has been requested by a user. When pressed, the acceptance button Bb indicates that a person at customer services has accepted the support request. In ACT 23, the proxy-side support terminal 13 waits for the acceptance button Bb to be pressed (selected).

A customer service person touches the acceptance button Bb after checking notification screen 91. Once the acceptance button Bb is touched, the proxy-side support terminal 13 transmits an acceptance response event signal to the facility-side support terminal 23 that sent support request. The acceptance response event signal is output from the proxy-side support terminal 13 to the network 15 of the operation proxy system 10 and transmitted to the facility-side support terminal 23 via the communication server 11, the wide area network 30, the communication server 21, and the network 25 of the reception system 20.

Upon receiving the acceptance response event signal, the facility-side support terminal 23 outputs the support terminal ID set for the facility-side support terminal 23 to the proxy-side support terminal 13. The support terminal ID is an ID specific to the facility-side support terminal 23. In ACT 13, the facility-side support terminal 23 sets the screen of the touch panel 55 to a member check screen 82 (see FIG. 7). The member check screen 82 is a screen on which a nonmember button Bc is displayed together with operation guidance for members and nonmembers.

After checking the member check screen 82, a member can cause a member ID to be displayed on the smartphone then scanned by the scanner 56 of the facility-side support terminal 23. If the user is a nonmember, the nonmember user touches the nonmember button Bc. Note that, if the member ID is recorded in a physical member card or the like, it is also possible to input the member ID to the facility-side support terminal 23 by causing a card reader or the like to read data from the member card.

In ACT 14, the facility-side support terminal 23, waits for a member ID to be input or the nonmember button Bc to be touched after the member check screen 82 is displayed. Here, if a member ID is input, the facility-side support terminal 23 outputs a signal indicating the member ID to the proxy-side support terminal 13. If the nonmember button Bc is touched, the facility-side support terminal 23 outputs a signal indicating that the nonmember button Bc was touched to the proxy-side support terminal 13.

The support terminal ID output from the facility-side support terminal 23 to the proxy-side support terminal 13 is transmitted to the proxy-side support terminal 13 via the network 25, the communication server 21, the wide area network 30, the communication server 11, and the network 15 of the operation proxy system 10. In ACT 24, the proxy-side support terminal 13, which received the support terminal ID, sets the screen of the touch panel 55 to a code screen 92 (see FIG. 7).

The code screen 92 is a screen on which a two-dimensional code Co and a customer service start button Bd are displayed. The two-dimensional code Co represents (encodes) a company ID, a facility ID, and a proxy ID as a two-dimensional code. That is, the proxy-side support terminal 13 provides a support terminal ID acquired from the facility-side support terminal 23 to the proxy server 12 and inquires of the proxy server 12 about a company ID, a facility ID, and a proxy ID. The proxy server 12 refers to the reference table 43 and acquires a company ID, a facility ID, and a proxy ID stored in correlation with the provided support terminal ID. The proxy server 12 transmits the acquired company ID, the acquired facility ID, and the acquired proxy ID to the proxy-side support terminal 13. The facility-side support terminal 23 creates the two-dimensional code Co with the company ID, the facility ID, and the proxy ID received from the proxy server 12. The facility-side support terminal 23 displays the code screen 92 on which the two-dimensional code Co and the customer service start button Bd are arranged. The customer service start button Bd is an operation piece for instructing a start of support by customer services. However, at the present point in time, the customer service start button Bd is grayed out and selection of the customer service start button Bd is disabled. The customer service start button Bd cannot be selected/operated.

Note that the facility-side support terminal 23 may output a signal including not only the support terminal ID set for the facility-side support terminal 23 but also the company ID and the facility ID of the facility to the proxy-side support terminal 13. In that case, the proxy-side support terminal 13 may provide the support terminal ID, the company ID, and the facility ID acquired from the facility-side support terminal 23 to the proxy server 12 and inquire of the server 12 about a proxy ID. Note that the proxy-side support terminal 13 may be configured to store, in a storage unit thereof, the same table as the reference table 43. The proxy-side support terminal 13 may refer to the table stored therein and acquire the proxy ID instead of inquiring the proxy server about the proxy ID.

The proxy-side support terminal 13 then waits for the signal indicating the member ID was input or the signal indicating that the nonmember button Bc was touched. As explained above, the signal indicating the member ID or the signal indicating that the nonmember button Bc was touched is output from the facility-side support terminal 23. The signal is transmitted to the proxy-side support terminal 13 via the network 25, the communication server 21, the wide area network 30, the communication server 11, the network 15 of the operation proxy system 10 in order.

After receiving the signal indicating the member ID or the signal indicating that the nonmember button Bc was touched, in ACT 25, the proxy-side support terminal 13 displays member information on the code screen 92. That is, after receiving the signal indicating the member ID, the proxy-side support terminal 13 provides the member ID and the company ID to the proxy server 12 or the like. The proxy server 12 searches through the member database for the company 42 specified by the company ID and acquires member data matching the member ID. The proxy server 12 transmits the member data to the proxy-side support terminal 13. The proxy-side support terminal 13 displays the member information (a name, sex, age, and the like) included in the member data in an area not overlapping the two-dimensional code Co and the customer service start button Bd on the code screen 92. Consequently, the person in charge of customer services can read the member information on the code screen 92, and see the name, the sex, the age, and the like of the user who just requested the support.

On the other hand, upon receiving the signal indicating that the nonmember button Bc was touched, the proxy-side support terminal 13 displays guidance indicating that the user is a nonmember in the area not overlapping the two-dimensional code Co and the customer service start button Bd on the code screen 92. Consequently, the person in charge of customer services can see on the code screen 92 that the user who just requested the support is a nonmember.

The proxy-side support terminal 13 releases the gray-out (disabled state) of the customer service start button Bd and enables touch of the customer service start button Bd. In ACT 26, the proxy-side support terminal 13 waits for the customer service start button Bd to be touched.

The person in charge of customer services now touches the customer service start button Bd. After the customer service start button Bd is touched, the proxy-side support terminal 13 transmits a signal of a start response event to the facility-side support terminal 23. The signal of the start response event is transmitted to the facility-side support terminal 23 via the network 15, the communication server 11, the wide area network 30, the communication server 21 and the network 25 of the reception system 20 in order.

In ACT 15, the facility-side support terminal 23 sets the screen of the touch panel 55 as a facility-side customer service screen 83 (see FIG. 7). The facility-side customer service screen 83 is a screen on which an image captured by the imaging unit 57 of the proxy-side support terminal 13, that is, an image Pa including the face of the person in charge of customer services is displayed.

Similarly, in ACT 27, the proxy-side support terminal 13 sets the screen of the touch panel 55 as a proxy-side customer service screen 93 (see FIG. 7). The proxy-side customer service screen 93 is a screen on which an image captured by the imaging unit 57 of the facility-side support terminal 23, that is, an image Pb including the face of the user is displayed. The proxy-side customer service screen 93 displays a customer service end button Be. The customer service end button Be is for instructing an end of the support event.

The operator of the proxy-side support terminal 13, can provide customer services by a phone call with the user of the facility-side support terminal 23. The person in charge of customer services can thus help the user who cannot operate the self-service terminal 22. The person in charge of customer services can effectively operate the self-service terminal 22 on behalf of the user by using the proxy terminal 14. An operation when the person in charge of customer services operates the self-service terminal 22 on behalf of the user is explained below.

The person in charge of customer services touches the customer service end button Be to end the support event. In ACT 28, the proxy-side support terminal 13 waits for the customer service end button Be to be touched. After the customer service end button Be is touched, the proxy-side support terminal 13 transmits a signal of an end response event to the facility-side support terminal 23. The signal of the end response event is transmitted to the facility-side support terminal 23 via the network 15, the communication server 11, the wide area network 30, the communication server 21, and the network 25 of the reception system 20.

In ACT 16, the facility-side support terminal 23, sets the screen of the touch panel 55 as a reception end screen. The reception end screen is an optional screen to be displayed. For example, the reception end screen only has to make it possible to recognize that the user completed the reception job.

In ACT 29, the proxy-side support terminal 13 sets the screen of the touch panel 55 as a proxy end screen. The proxy end screen is optional. For example, the proxy end screen only has to make it possible to recognize that the proxy operation has ended.

The facility-side support terminal 23 then returns to ACT 11 after a fixed time elapses or the like. That is, the facility-side support terminal 23 returns the screen of the touch panel 55 to the reception initial screen.

Similarly, the proxy-side support terminal 13 returns to ACT 21 after a fixed time elapses or the like. That is, the proxy-side support terminal 13 returns the screen of the touch panel 55 to the proxy initial screen.

### Operation of the Proxy Terminal

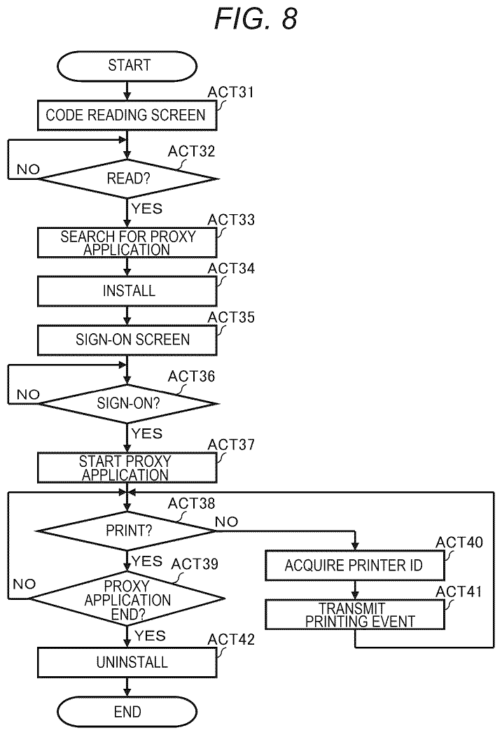

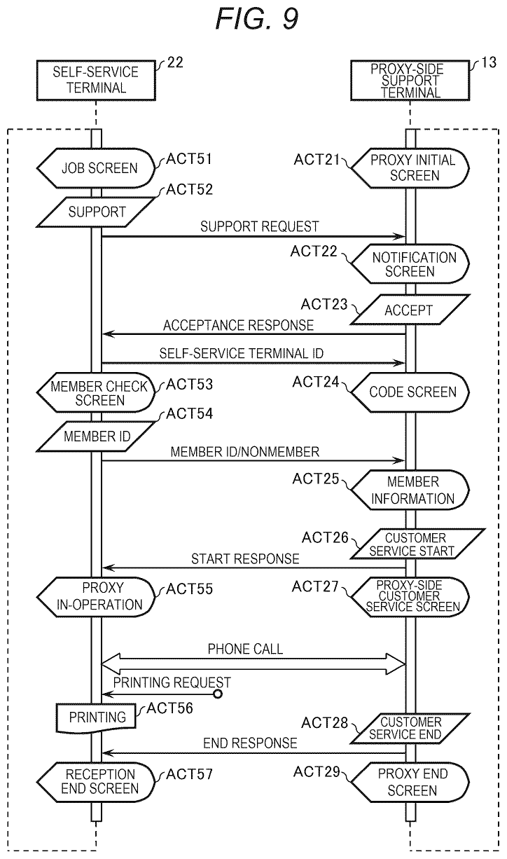

Next, an operation in the case in which the person in charge of customer services operates the self-service terminal 22 on behalf of the user is explained with reference to a flowchart of FIG. 8. FIG. 8 is a flowchart illustrating information processing that the processor 61 of the proxy terminal 14 executes according to a proxy control program. The proxy control program is a type of the application software installed in the main memory 62 or the auxiliary storage device 63. A method of installing the proxy control program in the main memory 62 or the auxiliary storage device 63 is not particularly limited. The proxy control program can be recorded in a removable recording medium or the proxy control program may be distributed by communication via a communication network and installed in the main memory 62 or the auxiliary storage device 63. The format of the recording medium does not particularly matter so long as the recording medium can store programs and be read by a computer device or the like. For example, the recording medium may be a CD-ROM, a memory card, or the like.

In the proxy terminal 14, after the proxy control program starts, the processor 61 starts the information processing corresponding to the flowchart of FIG. 8. In ACT 31, the processor 61 sets the screen of the touch panel 66 as a code reading screen. The code reading screen is a screen for urging reading of the two-dimensional code Co displayed on the code screen 92 of the proxy-side support terminal 13. In ACT 32, the processor 61 of the proxy terminal 14, waits for the two-dimensional code Co to be read.

The person in charge of customer service checks for the code screen 92 to be displayed on the touch panel 55 of the proxy-side support terminal 13 and then operates the scanner 67 of the proxy terminal 14 in order to read the two-dimensional code Co on the code screen 92 before touching the customer start button Bd. After the two-dimensional code Co is read by this operation, the processor 61 proceeds to ACT 33. In ACT 33, the processor 61 executes search processing for a proxy application.

Specifically, the processor 61 acquires a company ID, a store ID, and a proxy ID from the two-dimensional code Co and checks the proxy server 12 for a proxy application associated with the company ID, the store ID, and the proxy ID. The proxy server 12 searches through the reference table 43 and acquires an application ID stored in correlation with the company ID, the store ID, and the proxy ID. The proxy server 12 reads, from the application database 41, the proxy application specified by the application ID and sends the proxy application to the proxy terminal 14.

The processor 61 of the proxy terminal 14 then proceeds to ACT 34. In ACT 34, the processor 61 installs the downloaded proxy application. An installation destination for the proxy application may be the main memory 62 or may be the auxiliary storage device 63. The processor 61 of the proxy terminal 14 proceeds to ACT 35. In ACT 35, the processor 61 sets the screen of the touch panel 66 to a sign-on screen. The sign-on screen is a screen for receiving a sign-on (login) operation from the person in charge of customer services. In ACT 36, the processor 61 of the proxy terminal 14 waits for sign-on.

The person in charge then performs the operation for the sign-on. For example, the person in charge presses a sign-on key on the keyboard 65 and further operates a numeric keypad to input an employee code. After the sign-on is concluded successfully, the processor 61 proceeds to ACT 37. In ACT 37, the processor 61 starts the proxy application.

After the proxy application starts, the proxy terminal 14 can operate in substantially the same manner as the self-service terminal 22 executing a self-service terminal application equivalent to the proxy application. For example, if a proxy application equivalent to a self-service terminal application of a self-service terminal 22 of a karaoke bar is installed, the proxy terminal 14 operates to sequentially display screens for receiving input of a member ID, input of the number of users, selection of a karaoke course (a usage time, all-you-can-drink, and the like), and the like.

The person in charge touches the customer service start button Bd of the code screen 92 displayed on the touch panel 55 of the proxy-side support terminal 13. The person in charge makes a phone call to the user who cannot operate the self-service terminal 22, elicits information necessary for the reception job from the user, operates the keyboard 65 or the touch panel 66 of the proxy terminal 14 as appropriate, and thus inputs the appropriate information to the proxy terminal 14.

For example, a person in charge of customer service, who is supporting a user who cannot operate the self-service terminal 22 of a karaoke bar, asks the user whether the user is a member of the karaoke bar. If the user is a member, the person in charge can ask for a member ID from the user and input the member ID to the proxy terminal 14. Next, the customer service person asks the user for the number of users and inputs the number of users to the proxy terminal 14. The customer service person then asks the user about a desired karaoke course (options) and inputs the desired karaoke course selections to the proxy terminal 14. After the input of the information necessary for the reception job is ended in this way, a printing request event for a reception slip is generated by the proxy terminal 14.

In ACT 38, the processor 61 waits for the printing request event to be generated or, in ACT 39, waits for the proxy application to end. After the printing request event is generated, the processor 61 proceeds to ACT 40. In ACT 40, the processor 61 executes acquisition processing for a printer ID. Specifically, the processor 61 inquires of the proxy server 12 about a printer ID associated with the company ID, the store ID, and the proxy ID acquired from the two-dimensional code Co. The proxy server 12 searches through the reference table 43 and acquires a printer ID stored in correlation with the company ID, the store ID, and the proxy ID. The proxy server 12 provides the printer ID to the proxy terminal 14.

The processor 61 of the proxy terminal 14 then proceeds to ACT 41. In ACT 41, the processor 61 transmits a printing request event signal together with the printer ID. The printing request event signal is transmitted via the network 15 to the communication server 11, and the wide area network 30, the communication server 21 of the reception system 20 including the facility-side support terminal 23 on which the support button Ba was touched. Further, the printing request event signal is output to the printer 24 specified by the printer ID via the network 25 according to the control of the communication server 21. Consequently, the printer 24 operates and a reception slip is printed. Therefore, the user who was making the support phone call with customer service via the facility-side support terminal 23 can acquire the reception slip dispensed from the printer 24.

The processor 61 executes the processing in ACT 40 and ACT 41 every time a printing request event is generated in the waiting state of ACT 38 and ACT 39. If the proxy application ended in the waiting state of ACT 38 and ACT 39, the processor 61 proceeds to ACT 42. In ACT 42, the processor 61 uninstalls the proxy application. Then, the processor 61 ends the information processing conforming to the proxy control program.

### Action Effects of the First Embodiment

With the system including the operation proxy system 10, even if the user cannot operate a self-service terminal 22, a customer service person at the support center can complete the reception job for the user by eliciting necessary information through a phone call with the user and operating the proxy terminal 14 accordingly. Therefore, it is possible to quickly finish the reception job of the user who cannot successfully operate the self-service terminal 22. As a result, it is possible to avoid crowding at the reception.

The operations required of the user at the facility-side support terminal 23 is limited to touching the support button Ba displayed on the reception initial screen 81 and inputting a member ID or touching the nonmember button Bc if not a member. By this arrangement, a user who cannot easily operate the self-service terminal 22 can generally receive remote support.

At the facility side, it may be unnecessary to station or provide an employee at the reception area to support self-service operations. Therefore, it is possible to achieve manpower saving.

In the support center, a single proxy terminal 14 can cope with proxy of operations for reception jobs at self-service terminals 22 of many different businesses and businesses of different types of categories. Therefore, it is possible to lower overall system costs. Since a single customer service representative can usually cope with reception jobs for many different business categories, it is also possible to reduce labor costs.

Note that it is explained above that the facility-side support terminal 23 may output a signal including the support terminal ID set for the facility-side support terminal 23 or a signal including the company ID and the facility ID of the facility to the proxy-side support terminal 13. However, the facility-side support terminal 23 is not limited to this. The facility-side support terminal 23 may have, beforehand, information indicating a proxy ID to be used for support and include the proxy ID in the information sent to the proxy-side support terminal 13 upon receiving the signal of the acceptance response event. In this case, the proxy-side support terminal 13 may generate a two-dimensional code using the company ID, the facility ID, and the proxy ID received from the facility-side support terminal 23.

### Second Embodiment

In the first embodiment, the user who cannot operate the self-service terminal 22 moves to the facility-side support terminal 23 and receives the support by the remote customer service personnel. That is, the user has to move to the facility-side support terminal 23 in order to receive the remote customer support services. In a second embodiment in which the user can receive support by remote customer support services without moving to the facility-side support terminal 23.

In the second embodiment, the facility-side support terminal 23 and the printer 24 are not used or included in the reception system 20. Self-service terminal IDs of the self-service terminals 22 incorporated in a reception system 20 are set in the column Ca and the column Cf of the reference table 43.

The self-service terminal 22 includes a voice circuit 58 with a speaker 581 and a microphone 582 similar to those of the facility-side support terminal 23. That is, the self-service terminal 22 itself enables data communication such as a phone call to the proxy-side support terminal 13 in the operation proxy system 10. The user who cannot operate the self-service terminal 22 can receive support for a reception job or an adjustment job by making a phone call to customer service through the self-service terminal 22.

### Operation Example of the Second Embodiment

FIG. 9 is a sequence chart illustrating operations of the self-service terminal 22 included in a reception system 20 and the proxy-side support terminal 13 included in operation proxy system 10. Since operations of the proxy-side support terminal 13 are substantially the same as in the first embodiment, the same reference symbols used in FIG. 6 are used in FIG. 9 and additional explanation of these operations or aspects is limited.

As illustrated in FIG. 9, the self-service terminal 22 sets the screen of the touch panel 55 to a job screen in ACT 51. The job screen is a screen for receiving operation inputs to the self-service terminal 22 from a user or the like. For example, the self-service terminal 22, which processes a reception job of a karaoke bar, sequentially displays, as job screens, screens for receiving input of a member ID, input of the number of users, selection of a karaoke course (a usage time, all-you-can-drink, and the like), and other information as appropriate. In the second embodiment, the support button Ba is displayed on all the job screens. A user who cannot operate a displayed job screen touches the support button Ba. In ACT 52, if the support button Ba was touched, the self-service terminal 22 transmits a support request event signal to the proxy-side support terminal 13.

The self-service terminal 22, which transmitted the signal of the support request event, waits for a signal of an acceptance response event output from the proxy-side support terminal 13. The self-service terminal 22, which received the signal of the acceptance response event, outputs a signal of a self-service terminal ID set for the self-service terminal 22 to the proxy-side support terminal 13. In ACT 53, the self-service terminal 22 sets the screen of the touch panel 55 as a member check screen.

Here, a nonmember user touches the nonmember button Bc. A member user operates a scanner or a card reader of the self-service terminal 22 to input a member ID. Note that, if a member ID is already input on an input screen for a member ID on the job screen, the input of a member ID can be omitted. If a member ID is input or the nonmember button Bc is touched, the self-service terminal 22 outputs, to the proxy-side support terminal 13, a signal indicating the member ID or a signal indicating that the nonmember button Bc was touched.

The self-service terminal 22 waits for a start response event signal. If receiving the start response event signal, in ACT 55, the self-service terminal 22 sets the screen of the touch panel 55 as a proxy in-operation screen. The proxy in-operation screen is a screen for letting the user know that a customer service person is presently operating the self-service terminal 22 on behalf of the user. By setting the screen of the touch panel 55 to the proxy in-operation screen, it is possible to prevent the user from erroneously attempting to operate the touch panel 55.

The self-service terminal 22, on which the proxy in-operation screen is displayed, eventually comes into a calling state and makes a support phone call to the proxy-side support terminal 13. In this way, the user makes a phone call to an operator of the proxy-side support terminal 13. By the phone call, the user can receive support by remote customer service.

The self-service terminal 22 waits for a printing request event signal. Upon receiving the printing request event signal from the proxy terminal 14 together with the self-service terminal ID of the self-service terminal 22, in ACT 56, the self-service terminal 22 executes printing processing. That is, the self-service terminal 22 controls a printer and prints data related to the printing request event on a printing medium.

The self-service terminal 22 waits for an end response event signal. Upon receiving the end response event signal, the self-service terminal 22 sets the screen of the touch panel 55 to a reception end screen.

### Action Effects of the Second Embodiment

According to the second embodiment, the user who cannot operate the self-service terminal 22 can receive support from the operation proxy service by making a phone call via the self-service terminal 22 to speak with a person in charge of customer service. Therefore, the user can end the reception job without moving to where the facility-side support terminal 23 is installed. Moreover, some facilities may consider the support terminals 23 to be unnecessary in view of the improvements associated with the operation proxy service and self-service terminals 22, there may be an additional advantage that overall system costs can be reduced.

### Modifications

In the second embodiment, the self-service terminal 22, which received the signal of the acceptance response event, transmits the self-service terminal ID of the self-service terminal 22 to the proxy-side support terminal 13. However, in other examples, the self-service terminal 22 may transmit the self-service terminal ID of the self-service terminal 22 and the company ID and the facility ID to the proxy-side support terminal 13 together. In this case, the proxy-side support terminal 13 creates a two-dimensional code Co with the self-service terminal ID, the company ID, and the facility ID received from the self-service terminal 22. By adopting such a configuration, it is possible to reduce a processing load required for the creation of the two-dimensional code Co.

In the second embodiment, the proxy terminal 14 operates with the self-service terminal ID received from the self-service terminal 22. However, as in the first embodiment, the proxy terminal 14 may operate with a proxy ID other than the self-service ID of the self-service terminal 22.

In the first embodiment, the company ID, the facility ID, and the proxy ID are input to the proxy terminal 14 via the scanning the two-dimensional code Co. However, in some cases, least one of the company ID, the facility ID, and the proxy ID may be manually input to the proxy terminal 14 instead.

In an embodiment, the person in charge of customer service (the person who confirmed that the code screen 92 was displayed on the touch panel 55 of the proxy-side support terminal 13) operates the scanner 67 of the proxy terminal 14 in order to read the two-dimensional code Co from the code screen 92 before touching the customer service start button Bd. However, the person in charge of customer service can also cause the proxy-side customer service screen 93, which is displayed when the customer service start button Bd is touched, to display the two-dimensional code Co. Consequently, the person in charge of customer service can read the two-dimensional code Co even after touching the customer service start button Bd. Therefore, it is possible to prevent an operation mistake of touching the customer service start button Bd before the reading of the two-dimensional code Co.

In an embodiment, an operation proxy system 10 that can remotely perform a self-service terminal operation on behalf of the user who uses the facilities of the various business categories is described. In other examples, the operation proxy system 10 may be dedicated to helping users a facilities of a single business category or a single facility. In this case, since just one type of a self-service terminal application is implemented in the self-service terminals 22, the application database 41 can be omitted. It may be unnecessary to install and uninstall the proxy application in the proxy terminal 14.

Even if the self-service terminal operation is to be remotely performed on behalf of users of facilities of the various business categories, a plurality of self-service terminal applications can be installed in the proxy terminal 14 in advance. If a company ID, a facility ID, and a proxy ID are input, the proxy terminal 14 may start a self-service terminal application corresponding to the input identifying information. In this case, it may be unnecessary to install and uninstall the proxy application in the proxy terminal 14.

An output device specified by the second specifying means 74 is not limited to a printer. For example, information to be printed on a reception slip can instead be recorded in an RFID tag and dispensed to the user, the output device may be an RFID reader. Similarly, information can be recorded in a magnetic card or an IC card, and a card reader can be the output device. Similarly, information can be recorded in a user's smartphone or the like by short range wireless communication and a short range wireless communication unit can be the output device.

While certain embodiments of the present disclosure have been described, these embodiments are presented simply as examples and are not intended to limit the scope of the present disclosure. These novel embodiments can be implemented in various other forms and can include various omissions, replacements, and changes without departing from the spirit and scope of the present disclosure. These embodiments and modifications thereof are included in the spirit and scope of the present disclosure and also included in the scope of the claims and equivalents thereof.

What is claimed is:

1. A remote customer service operation proxy system, comprising:
a communication server connectable to a plurality of customer reception systems at a plurality of remote locations;
a proxy server connected to the communication server by a local network;
a proxy-side support terminal connected to the local network; and
a proxy terminal connected to the local network, wherein the proxy-side support terminal is configured to:
receive, via the communication server, a request for customer service from a customer reception system among the plurality of customer reception systems, and
identify a self-service terminal corresponding to the customer reception system sending the request, and the proxy terminal is configured to:
receive the identity of the self-service terminal,
execute a reception system program corresponding to the identified self-service terminal, and
output, via the communication server, a reception system completion notification to an output device corresponding to the identified self-service terminal.

2. The remote customer support operation system according to claim 1, wherein the proxy-side proxy terminal is configured to perform a video call with the customer reception system that sent the request.

3. The remote customer support operation system according to claim 1, wherein the output device is a printer.

4. The remote customer support operation system according to claim 1, wherein the proxy-side support terminal is configured to display a two-dimensional code indicating the identified self-service terminal.

5. The remote customer support operation system according to claim 4, wherein the proxy terminal includes a scanner to read the two-dimensional code displayed by the proxy-support terminal.

6. The remote customer support operation system according to claim 5, wherein the proxy terminal is configured to download the reception system program from the proxy server based upon reading the two-dimensional code.

7. The remote customer support operation system according to claim 1, wherein the customer reception system includes a facility-side support terminal dedicated to remote customer support and the reception system program is a program matching that used by a self-service customer terminal for customer reception processing.

8. The remote customer support operation system according to claim 1, wherein the self-service terminal is a facility-side support terminal.

9. The remote customer support operation system according to claim 1, wherein
the self-service terminal is a self-service customer support terminal for customer reception processing, and
the output device is a printer of the self-service customer terminal.

10. The remote customer support operation system according to claim 1, wherein the proxy-side support terminal provides the identity of the self-service terminal via the local network.

11. The remote customer support operation system according to claim 1, wherein the proxy-side support terminal provides an identification of the output device to the proxy terminal.

12. The remote customer support operation system according to claim 1, wherein the proxy terminal obtains an identification of the output device from the proxy server based on the identity of the self-service terminal.

13. A remote customer support proxy terminal, comprising:
a communication interface connected to a local network connected to a proxy server, a communication server, and a proxy-side support terminal; and
a processor configured to:
receive an identification code identifying a self-service terminal of a customer reception system at a remote location, the self-service terminal requesting remote customer support for a customer reception processing at the remote location;
execute a reception system program corresponding to the self-service terminal; and
output, via the communication server, a reception system completion notification to an output device corresponding to the identified self-service terminal.

14. The remote customer support proxy terminal according to claim 13, wherein the output device is a printer at the remote location.

15. The remote customer support proxy terminal according to claim 13, further comprising:
a scanner device, wherein the identification code is received via the scanner device.

16. The remote customer support proxy terminal according to claim 13, wherein the processor is further configured to request the reception system program from the proxy server after receiving the identification code.

17. The remote customer support proxy terminal according to claim 13, wherein
the self-service terminal is a self-service customer support terminal for customer reception processing, and
the output device is a printer of the self-service customer terminal.

18. The remote customer support proxy terminal according to claim 13, wherein the identification code is sent via the local network from the proxy-side support terminal.

19. A method for remote customer support operation systems, the method comprising:
receiving, via a communication server, a request for customer service from a customer reception system among a plurality of customer reception systems at a plurality of remote locations;
identifying a self-service terminal corresponding to the customer reception system sending the request;
receiving, at a proxy terminal, the identity of the self-service terminal;
executing, on the proxy terminal, a reception system program corresponding to the identified self-service terminal; and
outputting, via the communication server, a reception system completion notification to an output device corresponding to the identified self-service terminal.

20. The method according to claim 19, wherein the output device is a printer of the self-service terminal.
